(19) United States
(12) Patent Application Publication
(10) Pub. No.: US 2006/0283921 A1
(43) Pub. Date: Dec. 21, 2006

(54) Method of diffusion bonding of nickel based superalloy substrates

(75) Inventors: Steve Ciona, Hamilton (CA); Paul Van Der Weg, Burlington (CA); Steve Pryce, Burlington (CA); Barrie Abraham, Milton (CA); Rafael Castillo, Hamilton (CA)

Correspondence Address: Siemens Corporation;Intellectual Property Department, 170 Wood Avenue South, Iselin, NJ, 08830, US

(73) Assignee: Siemens Westinghouse Power Corporation

(21) Appl. No.: 11/153,101

(22) Filed: Jun. 15, 2005

(51) Int. Cl. B23K 35/12; B23K 20/00

(52) U.S. Cl. 228/246

(57) ABSTRACT

A method of transient liquid phase bonding includes the use of an interlayer between the two substrates to be bonded that is alloyed with a melting point reducing element. The interlayer forms a liquid during the bonding process, resulting in superior surface contact between the interlayer and substrates during the bonding process. As the melting point decreaser diffuses out of the interlayer, the interlayer resolidifies, at which point bonding continues under the principles of diffusion bonding.

### BACKGROUND OF THE INVENTION

1. Field of the Invention

The present invention relates to joining substrates together to form laminated structures. More specifically, the invention provides a method of diffusion bonding of substrates into laminated structures.

2. Description of the Related Art

Substrates made from materials such as high nickel steels are presently joined into laminated structures by techniques such as brazing and diffusion bonding.

Brazing is a means of joining metals with a filler metal therebetween, with the filler metal having a melting point substantially below that of the metals to be joined. The joint is formed by heating the metals above the melting point of the filler metal, but below the melting point of the substrates. Typical filler metals include copper, copper alloys, silver, silver alloys, and aluminum alloys. Although brazing may be done quickly and economically, and produces a relatively strong joint, the joints produced by brazing are not as strong as the joints produced by other joining methods, and can be damaged by heat.

Diffusion bonding involves the joining of a pair of substrates under heat and pressure. The temperature is sufficient to permit atoms from the two substrates to diffuse into each other, or if an intermediate layer is used, for atoms from each substrate and the intermediate layer to diffuse into each other. Diffusion bonding requires significantly more time than brazing to perform. Pure nickel is typically used as an interlayer. Surface roughness prevents ideal contact between substrates to be joined, thereby decreasing the mechanical properties of the joint. Although some of the problem may be overcome by adding pressure to force contact between the substrates, acceptable pressure levels are limited by the deformation limits of the substrates, and the mechanical properties of the joints have still been found to vary.

Transient liquid phase bonding is disclosed in U.S. Pat. No. 3,678,570, issued to D. F. Paulonis on Jul. 25, 1972, and in D. S. Duvall, W. A. Owczarski and D. F. Paulonis, “TLP Bonding: a New Method for Joining Heat Resistant Alloys,” Welding Journal, April 1974, at 203. One of the advantages of transient liquid phase bonding cited by the Paulonis article is the absence of a requirement for a process such as electroplating. While the Paulonis patent includes an example including an electroplated interlayer, neither the article nor the patent discloses the specific advantages of electroless nickel plating of the interlayer.

Accordingly, an improved method of joining substrates to form laminates, that produces an interlayer with a more even thickness, and therefore produces stronger joints, is desired.

### SUMMARY OF THE INVENTION

The present invention provides an improved method of diffusion bonding substrates together to produce laminated articles. The joining method, hereinafter referred to as transient liquid phase bonding, involves applying a nickel plating to the joining surfaces of a set of substrates using an electroless rocess, and then joining the substrates using heat and pressure. The interlayer is alloyed with a melting point reducer, for example, the addition of boron to a nickel interlayer. As temperature and pressure are applied to the substrates, the interlayer melts, with the resulting liquid providing essentially complete surface contact as it conforms to the irregularities in the substrate surfaces. The boron will simultaneously begin to diffuse away through the substrate material, causing the interlayer to resolidify while remaining in full contact with the substrate. At this point, the nickel atoms within the interlayer begin to diffuse into the substrate, with the substrate atoms diffusing into the nickel. Once resolidification is complete, the remainder of the process is essentially diffusion bonding but with much better surface to surface contact than with traditional diffusion bonding.

The use of electroless nickel plating to apply the interlayer results in bonds that have an interlayer with a more even thickness, a better grain structure, and better mechanical properties than traditional diffusion bonding.

Accordingly, it is an object of the present invention provide an interlayer in a diffusion bonding process that has a more uniform thinkness than other interlayers, and that is alloyed with an element that will lower its melting point and thereby improve surface-to-surface contact within the bond, and the strength of the resulting bond.

It is another object of the invention to provide improved surface to surface contact between the substrates and interlayer for a given surface roughness, thereby improving the mechanical properties of a bond.

It is a further object of the invention to provide a method of joining substrates together that is both economical and which produces stronger bonds than previous joining methods.

It is another object of the invention to provide a bonding method that produces a better grain structure than previous bonding methods.

It is a further object of the invention to reduce the need for extensive processing to reduce the surface roughness of the substrates to be joined.

These and other objects of the invention will become more apparent through the following description and drawings.

### BRIEF DESCRIPTION OF THE DRAWINGS

FIG. 1 is a side view of a pair of substrates prior to bonding according to the present invention.

FIG. 2 is a side view of a pair of substrates upon which an interlayer has been deposited for bonding according to the present invention.

FIG. 3 is a side view of a pair of substrates and interlayer immediately prior to bonding according to the present invention.

FIG. 4 is a side view of the Detail A in FIG. 6.

FIG. 5 is a side view of a substrate and intermediate layer after bonding according to the present invention.

FIG. 6 is a side view of the Detail B in FIG. 8.

FIG. 7 is a micrograph of a joint resulting from the present invention.

Like reference characters denote like elements throughout the drawings.

### DETAILED DESCRIPTION

The present invention provides a method of joining a pair of substrates having improved surface to surface contact between the substrates and an interlayer between the substrates. The method provides for an interlayer that is applied to the joining surfaces in a manner resulting in a more uniform thickness.

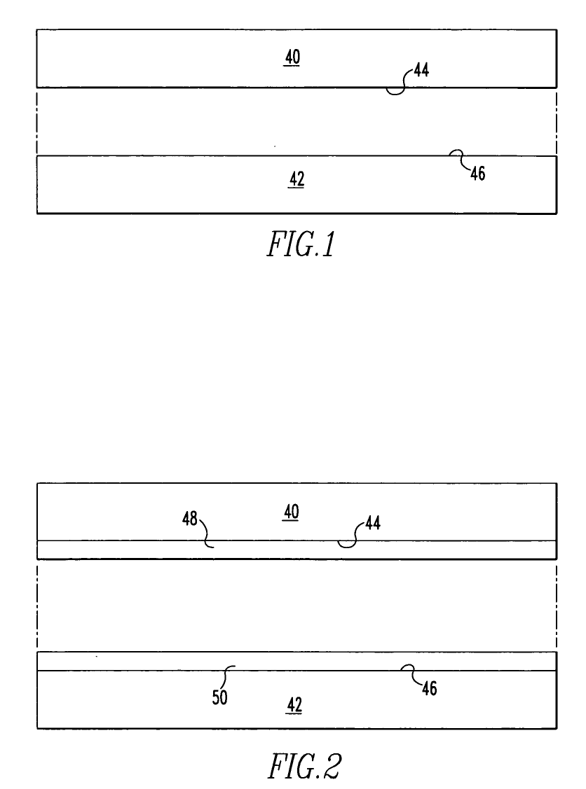

Referring to FIGS. 1-7, the method of joining substrates is illustrated. The substrates 40, 42 shown in FIG. 1 may in some preferred embodiments be high nickel steel, for example, Inconel Alloy 617 or other Inconel alloys, or other similar materials. These alloys may also include solid solution strengthened alloys, or gamma prime alloys. Initially, the surfaces 44, 46 of the substrates 40, 42 will be sanded and/or polished to minimize their surface roughness. In some preferred embodiments, the average roughness (Rₐ) should not exceed about 30 μin., which will provide sufficient surface roughness for good adhesion of an electroless nickel plating while also providing good surface to surface contact between the substrates to be joined.

Referring to FIG. 2, an interlayer 48, 50 is deposited on each of the surfaces 44, 46. While the interlayer 48, 50 may be provided over only one surface 44, 46, it is more preferable to provide the interlayer over both surfaces. The interlayers 48, 50 are nickel alloyed with about 0.1% to about 6% by weight boron. The weight percent boron may be controlled by the specific plating solution. Solutions using an alkylamineborane usually produce coatings having a boron content between 0.1% and 3.5% by weight. Solutions using sodium borohydride usually produce coatings having a boron content between 3.5% and 6% by weight. Cobalt and/or other alloys may be co-deposited to improve the bond strength. Boron acts as a melting point reducer within the nickel. The most preferred way of applying the interlayers 48, 50 to the surfaces 44, 46 is by electroless nickel plating. Alternative methods include application of a blended powder of nickel and boron, mixed with a binder, applied through the use of a spray gun, and the use of foils. The interlayers 48, 50 will typically be applied to a thickness of about 0.0001 inch to about 0.001 inch.

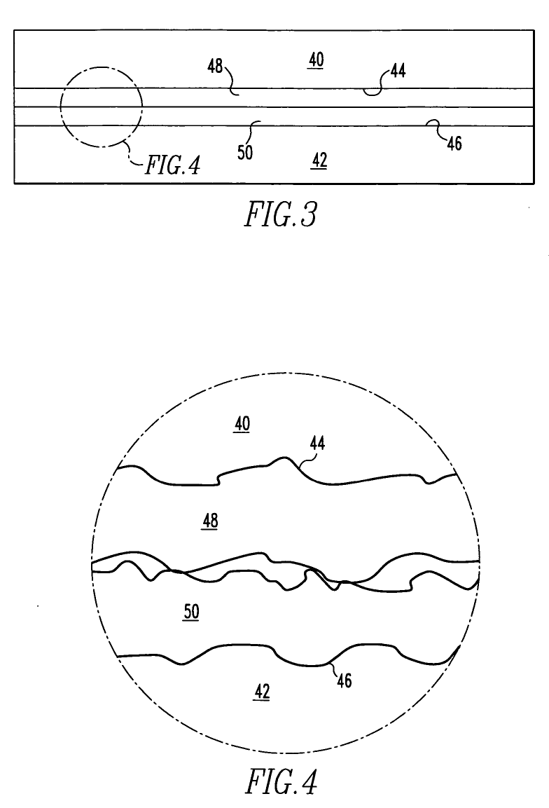

Referring to FIG. 3, the two interlayers 48, 50 are brought together, and the substrates 40, 42 placed between a pair of platens within a furnace. As shown in FIG. 4, the surface roughness not removed by the sanding and/or polishing results in less than perfect surface contact between the components to be joined, even with the application of pressure to the joint. The pressure applied by the transient liquid phase bonding method of the present invention may be as little as about 60 psi, with an upper limit being the deformation limit of the substrates 40, 42, which may in some examples be about 1,200 psi.

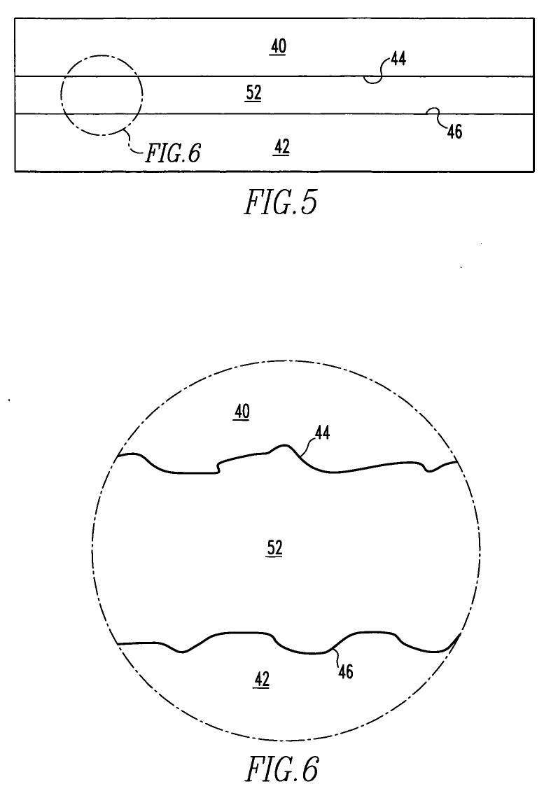

Referring to FIGS. 5 and 6, the substrates 40, 42 and interlayers 48, 50 are heated within a furnace while pressure is applied through the use of a hot press or HIP fixture. Typically, the substrates 40, 42 and interlayers 48, 50 will be heated to a temperature of about 1,800° F. to about 2,200° F. depending upon the specific substrates 40, 42 being bonded. At these temperatures, the presence of boron within the nickel interlayers 48, 50 causes the interlayers 48, 50 to melt. The liquid will conform to the irregularities in the surface, resulting in essentially 100% surface to surface contact between the substrates 40, 42 and interlayers 48, 50. Likewise, the now liquid interlayers 48, 50 will become the single interlayer 52. The boron will simultaneously begin to diffuse into the substrates 40, 42, causing the interlayer 52 to resolidify as the melting point reducer is removed, remaining in full contact with the substrates 40, 42. At this point, diffusion bonding continues to occur between the interlayer 52 and substrates 40, 42, with the substrates 40, 42 and interlayer 52 diffusing into each other. The superior surface to surface contact between the substrates 40, 42 and interlayer 52 provides greater opportunity for atoms to diffuse across the bonds, thereby forming a stronger bond.

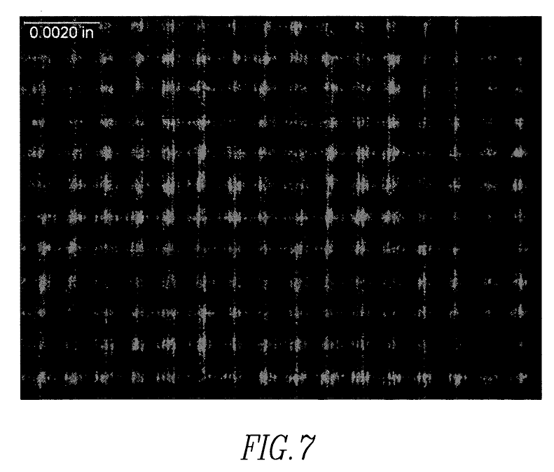

FIG. 7 is a micrograph of a bond according to the present invention. The very clean bond line without observable boride phases combined with good grain growth within the bond area is indicative of a strong bond.

The present invention therefore provides a method of diffusion bonding that provides superior bond strength to presently available diffusion bonding methods, without the need for extensive processing to eliminate surface roughness on the substrates to be bonded. The process provides a method of applying an interlayer having a substantially uniform thickness across the surfaces to be joined. The method therefore provides the advantages of both greater bond strength and greater efficiency and cost effectiveness.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the appended claims and any and all equivalents thereof.

What is claimed is:

1. A method of bonding a set of substrates, comprising:
providing a pair of substrates, each substrate defining a joining surface;
providing an interlayer over at least one joining surface by a procedure selected from the group consisting of electroless plating, spraying, and application of a foil, the interlayer being alloyed with a melting point reducer;
positioning the substrates with the joining surfaces facing each other; and
pressing the substrates together while subjecting the substrates and interlayer to a temperature above the melting point of the interlayer; whereby the interlayer melts to provide essentially complete surface to surface contact between each joining surface and the interlayer.

2. The method according to claim 1, further comprising reducing a surface roughness of each joining surface prior to providing an interlayer over each joining surface.

3. The method according to claim 2, wherein the surface roughness is reduced to a level wherein an average surface roughness is below about 30 μin.

4. The method according to claim 1, wherein the substrates are nickel, cobalt, and iron based superalloys.

5. The method according to claim 1, wherein the interlayer is nickel alloyed with boron.

6. The method according to claim 5, wherein the interlayer includes about 0.1% to about 6% boron.

7. The method according to claim 1, wherein bonding includes diffusion of the melting point reducer into the substrates after the interlayer has melted, resolidification of the interlayer, and diffusion bonding.

8. The method according to claim 1, wherein the interlayer has a thickness of about 0.0001 inch to about 0.001 inch.
